(19) United States
(12) Patent Application Publication
(10) Pub. No.: US 2009/0086018 A1
(43) Pub. Date: Apr. 2, 2009

(54) PROCESSING METHOD OF IMAGE ACQUIRING IN BODY LUMEN, CAPSULE ENDOSCOPE AND CAPSULE ENDOSCOPE SYSTEM USING IT

(75) Inventors: Han Bo Shim, Seongnam (KR); Won Woo Cho, Yongin (KR); Jung Jin Hwang, Daejeon (KR); Kwang Seop Kim, Daejeon (KR); Young Dae Seo, Daejeon (KR); Han Jung, Daejeon (KR); Byung Hyuk Kim, Daejeon (KR); Yong Un Kim, Daejeon (KR)

Correspondence Address: Workman Nydegger;1000 Eagle Gate Tower, 60 East South Temple, Salt Lake City, UT, 84111, US

(73) Assignee: INTROMEDIC CO., LTD, Seoul (KR)

(21) Appl. No.: 12/298,872

(22) PCT Filed: Apr. 26, 2007
(86) PCT No.: PCT/KR07/02045

§ 371 Date: Oct. 28, 2008

(30) Foreign Application Priority Data
Apr. 28, 2006 (KR) 10-2006-0038952

(51) Int. Cl. H04N 7/22; G06K 9/00

(52) U.S. Cl. 348/68; 382/274; 382/128; 348/E07.094

(57) ABSTRACT

The present invention relates to a method for processing an image in a capsule endoscope and capsule endoscope system that processes an internal human body image acquired by a capsule type endoscope swallowable into a human body. The present invention includes a step (a) of acquiring a light emitting image consecutively in a light emitting mode, a step (b) of acquiring a no-light image in a no-light mode after elapse of a prescribed time, and a step (c) of correcting the light emitting image acquired in the step (a) using the no-light image acquired in the step (b). According to the present invention, noises attributed to dark-current and heat occurring in an image of taking an internal human body can be corrected and a quality of an internal human body image can be enhanced using an effective part of a no-light image only in removing dark-current noise and thermal noise.

### TECHNICAL FIELD

The present invention relates to a method for processing an image in a capsule endoscope and capsule endoscope system, and more particularly, to a method for processing an image in a capsule endoscope and capsule endoscope system that processes an internal human body image acquired by a capsule type endoscope swallowable into a human body.

### BACKGROUND ART

Recently, a capsule type endoscope has been developed and used in diagnosing various diseases in a medical field. The capsule type endoscope, which is swallowed by a user, takes pictures of an internal human body and then transmits the taken pictures to an external device via wireless communication. So, the capsule type endoscope is advantageous in precisely diagnosing various internal organs including a small intestine, which was unable to be acquired by a conventional endoscope, without anesthesia and nausea.

### DISCLOSURE OF THE INVENTION

A capsule endoscope obtains an image of an internal human body via an image sensor. Yet, since dark current flows in the image sensor at a part where an incident light fails to exist, dark-current shot noise may be generated in the image taken by the capsule endoscope. Moreover, since thermal energy may occur in an electronic circuit including the image sensor, thermal noise may occur in the image taken by the capsule endoscope. In particular, the image of the internal human body taken by the capsule endoscope is very dark, the influences of the dark-current noise and the thermal noise are considerably significant despite using a light source such as an LED and the like. So, a quality of the taken image is considerably degraded.

Accordingly, the present invention is directed to obviate one or more of the problems due to limitations and disadvantages of the related art.

An object of the present invention is to provide a capsule endoscope system and image processing method thereof, by which noises attributed to dark-current and heat occurring in an image of taking an internal human body can be corrected.

Another object of the present invention is to provide a capsule endoscope system and image processing method thereof, by which a quality of an internal human body image can be enhanced using an effective part of a no-light image only in removing dark-current noise and thermal noise.

### BRIEF DESCRIPTION OF THE DRAWINGS

FIG. 1 is a configurational diagram of a capsule endoscope system according to one embodiment of the present invention.

FIG. 2 is a diagram o a bayer pattern.

FIG. 3 is a diagram of image sensors arranged for a bayer pattern.

FIG. 4 is a configurational diagram of a capsule endoscope system according to another embodiment of the present invention.

FIG. 5 is a flowchart of an image acquiring process in an image processing method of a capsule endoscope system according to the present invention.

FIG. 6 is a diagram of a relation between acquiring and a presence or non-presence of luminescence in the present invention.

FIG. 7 is a flowchart of an image processing process in an image processing method of a capsule endoscope system according to the present invention.

FIG. 8 is a diagram of an example of a histogram for validity check according to the present invention.

FIG. 9 is a diagram of bayer patterns of a light-emitting image, a no-light image, and a corrected image according to the present invention.

FIG. 10 is a diagram of examples of a light-emitting image, a no-light image, and a corrected image according to the present invention.

### DESCRIPTIONS OF REFERENCE NUMBERS

100, 101: capsule endoscope
110, 111: lens
120, 121: light source (LED)
130, 131: image sensor
140, 141: control unit
150, 151: power unit
160, 161: transmitting unit
171: image processing unit
200: external processing device
210: receiving unit
220: image processing unit
230: display

### BEST MODE FOR CARRYING OUT THE INVENTION

To achieve these and other advantages and in accordance with the purpose of the present invention, as embodied and broadly described, a method for processing an image acquired within a body by a capsule endoscope, comprising the step of (a) acquiring an image in a light emitting mode (b) acquiring an image in a no-light mode; and (c) correcting the image acquired in the light emitting mode by the image acquired in the no-light mode.

Preferably, the step (c) includes determining whether an image acquired in the step (a) and the step (b) is a light emitting image acquired in the light emitting mode or a no-light image acquired in the no-light mode, extracting a correcting no-light image if the image is determined to be a no-light image, correcting the light emitting image by the correcting no-light image, and displaying the corrected light emitting image.

Preferably, the light emitting image and a no-light image determine pixels having a value over 30 amount to a value below 20%, it is determined as a no-light image.

Preferably, the correcting no-light image pixels having a value below 10 amount to a value over 95%, it is determined as a correcting no-light image.

Preferably, correcting of the light emitting image subtract the extracted correcting no-light image value from the light emitting image value.

A capsule endoscope for processing an image acquired within a body, comprising a light source flickering in correspondence to a control signal, an image sensor acquiring a light emitting image or a no-light image in correspondence to flickering of the light source, an image processing unit correcting by subtract the acquired no-light image from the acquired light emitting image, and a control unit controlling the flickering of the light source and the image processing.

Preferably, the image processing unit determine whether the acquired image is a light emitting image or a no-light image, extract a correcting no-light image if the acquired image is determined to be a no-light image, correct by subtract the extracted correcting no-light image value from the light emitting image value.

Preferably, the light emitting image and a no-light image determine pixels having a value over 30 amount to a value below 20%, it is determined as a no-light image.

Preferably, the correcting no-light image pixels having a value below 10 amount to a value over 95%, it is determined as a correcting no-light image.

A capsule endoscope system for processing an image acquired within a body, comprising a capsule endoscope transmitting a light emitting image acquired in the light emitting mode and a no-light image acquired in the no-light mode, and an external processor receive the light emitting image and the no-light image from the capsule endoscope, wherein the external processor correcting the received light emitting image by the received no-light image.

Preferably, the external processor includes, a receiving unit the receiving unit receiving a light emitting image and a no-light image from a capsule endoscope, an image processing unit correcting the light emitting image by the no-light image, and a display displaying the corrected image.

Preferably, the image processing unit determine whether the received image is a light emitting image or a no-light image, extract a correcting no-light image if the received image is determined to be a no-light image, correct by subtract the extracted correcting no-light image value from the light emitting image value.

Preferably, the light emitting image and a no-light image determine, pixels having a value over 30 amount to a value below 20%, it is determined as a no-light image.

Preferably, the correcting no-light image pixels having a value below 10 amount to a value over 95%, it is determined as a correcting no-light image.

Additional features and advantages of the invention will be set forth in the description which follows, and in part will be apparent from the description, or may be learned by practice of the invention. The objectives and other advantages of the invention will be realized and attained by the structure particularly pointed out in the written description and claims thereof as well as the appended drawings. It is to be understood that both the foregoing general description and the following detailed description are exemplary and explanatory and are intended to provide further explanation of the invention as claimed.

Reference will now be made in detail to the preferred embodiments of the present invention, examples of which are illustrated in the accompanying drawings.

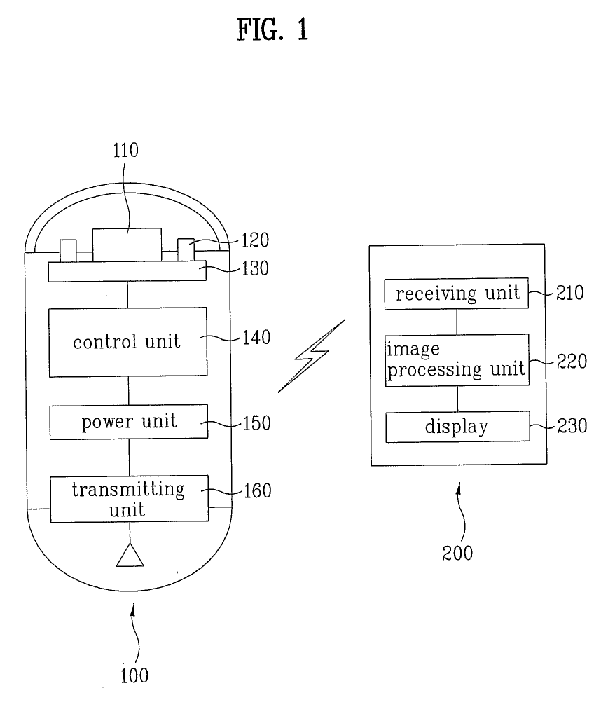

FIG. 1 is a configurational diagram of a capsule endoscope system according to one embodiment of the present invention.

Referring to FIG. 1, a capsule endoscope system according to one embodiment of the present invention includes a capsule endoscope 100 and an external processing device 200. And, the capsule endoscope 100 includes a lens 110, a light source 120, an image sensor 130, a control unit 140, a power unit 150, and a transmitting unit 160. Moreover, the external processing device 200 includes a receiving unit 210, an image processing unit 220, and a display 230.

The lens 110 of the capsule endoscope 100 is provided to collect a light such as an incident light and the like from outside.

The light source 120 is provided to illuminate an external environment. The light source 120 flickers according to a control signal. The light source 120 generally includes a light emitting diode (LED). A flickering cycle can be about 1 to 5 minutes, which does not put limitation on the present invention.

The image sensor 130 is provided to convert an incident light coming via the lens 110 to an image. The image sensor 130 obtains a light emitting image or a no-light image as the light source 120 flickers. In particular, the image sensor 130 is able to obtain a light emitting image by taking a photograph while the light source 120 is turned on. And, the image sensor 130 is able to obtain a no-light image by taking a photograph while the light source 120 is turned off. The image sensor 130 can include a CCD sensor or a CMOS sensor, which does not put limitation on the present invention. In this case, the light emitting image or the no-light image is in a bayer format and the image sensor 130 cal follow a bayer pattern, which does not put limitation on the present invention.

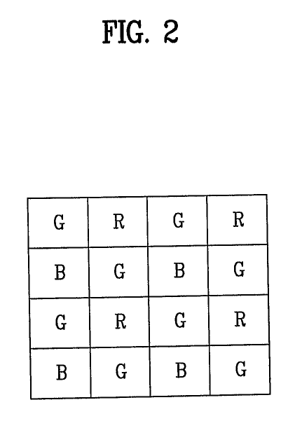

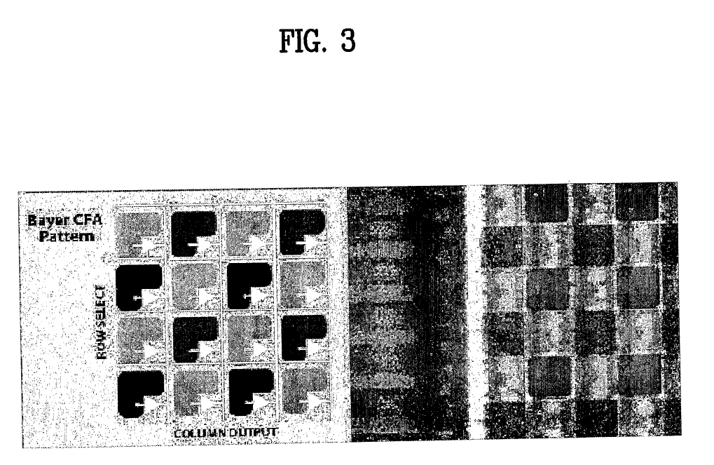

Meanwhile, the bayer pattern (bayer format) means that one pixel having one of red (R), green (G), and blue (B) can be represented as one value between 0˜255 according to chromaticity and that two colors failing to be provided to each pixel are calculated using a neighbor pixel value. FIG. 2 shows the bayer pattern and arrangement of image sensors for the bayer pattern is shown in FIG. 3. Referring to FIG. 2, it can be observed that one of red (R), green (G), and blue (B) is assigned to one pixel. Referring to FIG. 3, it can be observed that one pixel is provided with a sensor to read one of the three colors.

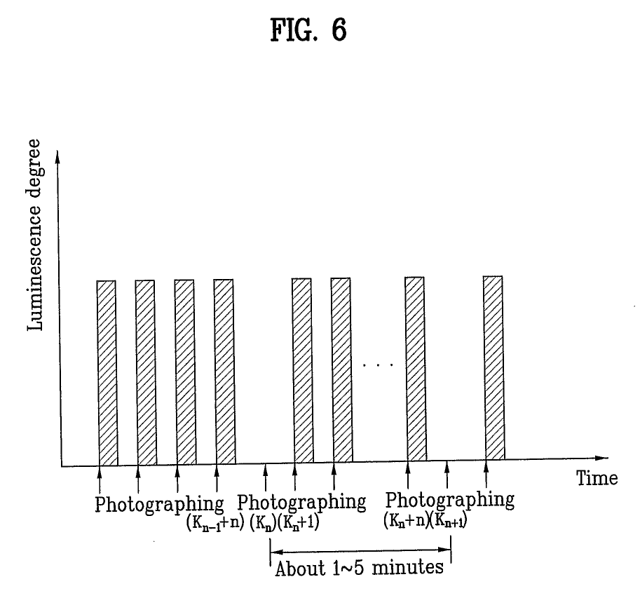

The control unit 140 controls flickering of the light source 120 and transfers the light emitting image or the no-light image received from the image sensor 130 to the external processing device 200 via the transmitting unit 160. In particular, the control unit 140 turns of the light source by delivering a control signal to the light source 120 each time a prescribed time goes by. In this case, the prescribed time is the same of the aforesaid flickering cycle and can be about 1˜5 minutes. Details for the relation between the acquiring and the presence or non-presence of the light emission will be explained later together with FIG. 6.

The power unit 150 is an element that supplies power to the capsule endoscope 100.

The transmitting unit 160 is a communication device that transmits a light emitting image or a no-light image to the external processing device 200 under the control of the control unit 140. For this, a general radio frequency system is usable, which does not put limitation on the present invention.

The receiving unit 210 of the external processing device 200 receives a light emitting image or a no-light image from the transmitting unit 160 of the capsule endoscope 100.

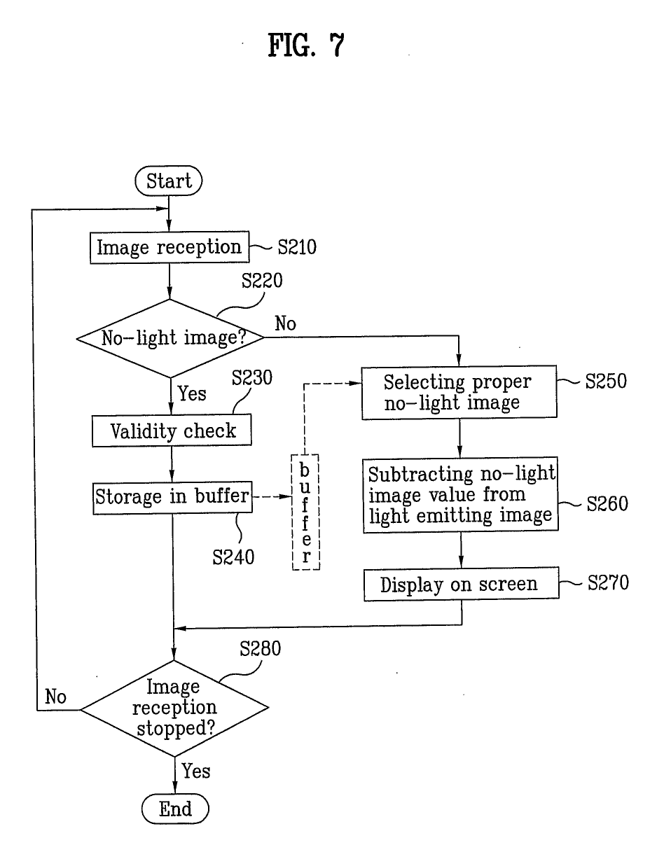

The image processing unit 220 corrects the light emitting image using the no-light image. In particular, the image processing unit 220 determines whether the image received via the receiving unit 210 is the light emitting image or the no-light image. In doing so, it is able to determine that the received image is the no-light image if pixels over a prescribed value among numerous pixels constructing the image amounts to a value below a prescribed percentage. If the received image is determined as the no-light image, a valid part of the no-light image is extracted and stored. In this case, the valid part indicates a part corresponding to pixels below the prescribed value among numerous pixels. Meanwhile, if the received image is determined as the light emitting image, a proper no-light image is preferentially selected. In this case, the proper image indicates a no-light image proper for correcting a specific light emitting image and means that a difference between a timing point of taking the light emitting image and a timing point of taking the no-light image is in a range of a prescribed time (e.g., about 30 seconds). After the proper no-light image has been selected, a corrected image resulting from subtracting a no-light image value from a specific light emitting image value is generated. And, corresponding details will be explained later with reference to FIGS. 7 to 10.

And, the display 230 is a display device that displays the corrected image generated by the image processing unit 220

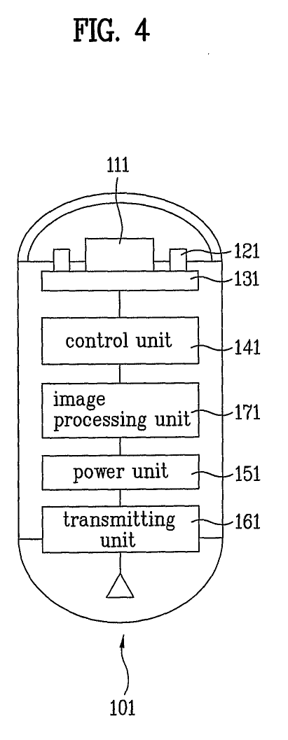

FIG. 4 is a configurational diagram of a capsule endoscope system according to another embodiment of the present invention.

Referring to FIG. 4, a capsule endoscope system according to another embodiment of the present invention includes a lens 111, a light source 121, an image sensor 131, a control unit 141, an image processing unit 171, a power unit 151, and a transmitting unit 161.

The lens 111, the light 121, the image sensor 131, the power unit 151, and the transmitting unit 161 of another embodiment of the present invention are the same elements of the lens 110, the light 120, the image sensor 130, the power unit 150, and the transmitting unit 160 of the former embodiment of the present invention, respectively. So, details of them are omitted in the following description.

The image processing unit 171 corrects a light emitting image using a no-light image. In this case, a procedure of correcting a light emitting image is almost equal to that performed by the image processing unit 220 of the external device 200 of the former embodiment of the present invention.

The control unit 141 delivers a light emitting image or a no-light image received from the image sensor 131 to the image processing unit 171 and makes a request for image processing. The control unit 141 then transmits a corrected image generated by the image processing unit 171 to an external processing device (not shown in the drawing) via the transmitting unit 161.

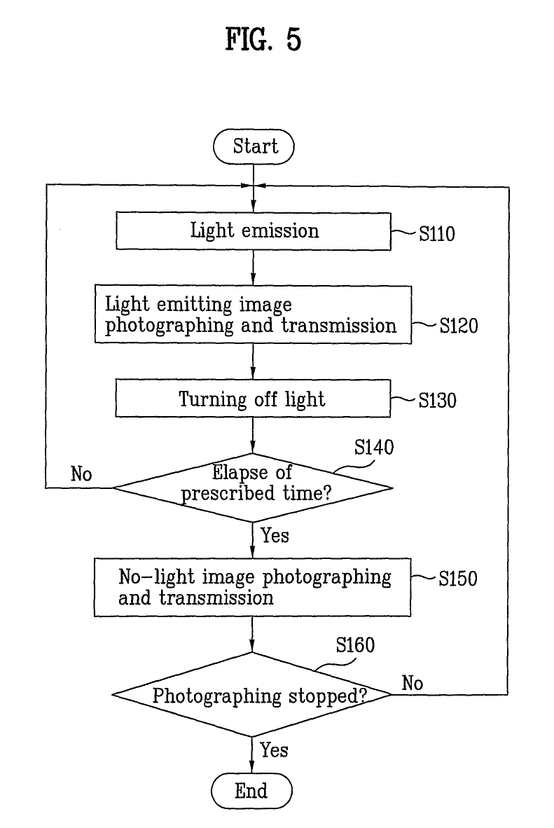

FIG. 5 is a flowchart of an image acquiring process in an image processing method of a capsule endoscope system according to the present invention.

Referring to FIG. 5, light emission is initiated by turning on a light source such as an LED (S110).

Subsequently, while the light source is turned on, a light emitting image is acquired. If an image processing unit 220 is provided to an external processing device 200 like the capsule endoscope system according to one embodiment of the present invention, the light emitting image is transmitted to the external processing device 200 (S120).

After completion of acquiring, the light source is turned off for saving electricity. Thus, the light source is immediately turned off after acquiring. This is to save the power. Since it is not to take a picture of a no-light image, it is not essential to the present invention.

It is then decided whether a prescribed time goes by after a no-light image has been taken (S140). In this case, the present time preferably corresponds to about 1 to 5 minutes.

FIG. 6 is a diagram of a relation between acquiring and a presence or non-presence of luminescence in the present invention.

Referring to FIG. 6, it can be observed that image acquirings are consecutively performed with a prescribed time interval in-between.

For instance, if a acquiring speed is 1 frame/second, acquiring is carried out with an interval of about one second. If a acquiring speed is 2 frames/second, acquiring is carried out with an interval of about 0.5 second.

Meanwhile, in FIG. 6, (Kₙ)^{th} and (Kₙ₊₁)^{th} acquirings can be carried out without light emission, whereas (K_{N-1}+n)^{th}, (Kₙ+1)^{st}, . . . and (Kₙ+n)^{th} acquirings are carried out in a light emitting mode. In other words, (Kₙ₋₁+n)^{th}, (Kₙ+1)^{st} . . . , and (Kₙ+n)^{th} acquired images become light emitting images and (Kₙ)^{th} and (Kₙ₊₁)^{th} acquired images becomes no-light images. In this case, each acquiring of a no-light image is preferably carried out each prescribed time (about 1˜5 minutes). Besides, the (Kₙ)^{th} acquired no-light image can be suitable for correction of the (K_{N-1}+n)^{th} and (Kₙ+1)^{st} acquired light emitting images And, the (Kₙ+1)^{st} acquired no-light image can be suitable for correction of the (K_{N}+n)^{th} and (Kₙ₊₁+1)^{st} acquired light emitting images.

Referring to FIG. 5 again, as a result of the decision in the step S140, if the prescribed time (about 1˜5 minutes) does not go by from the timing point of acquiring the no-light image (‘No’ in the step S140), the routine goes back to the step S110 to take a picture of a light emitting image. On the other hand, if the prescribed time (about 1˜5 minutes) goes by from the timing point of acquiring the no-light image (‘Yes’ in the step S140), a no-light image is acquired in a status of turning off the light source in the step S130, i.e., in a no-light mode. Since the no-light image in the no-light mode contains noise by dark current and thermal noise at the corresponding timing point, it can be used for image quality enhancement. After the no-light image has been acquired in the above manner, like the step S120, if an image processing unit 220 is provided to an external processing device 200 like the capsule endoscope system according to one embodiment of the present invention, the light emitting image is transmitted to the external processing device 200 (S150).

Thereafter, until the acquiring is stopped (‘Yes’ in the step S160), the routine goes back to the step S110 to consecutively perform acquirings.

FIG. 7 is a flowchart of an image processing process in an image processing method of a capsule endoscope system according to the present invention.

Referring to FIG. 7, if an image processing unit 220 is provided to an external processing device 200 like a capsule endoscope system according to one embodiment of the present invention, the external processing unit 200 receives a light emitting image or a no-light image from a capsule endoscope 100 (S210).

Subsequently, it is determined whether the received image is a light emitting image or a no-light image (S220). In this case, there can be various methods for deciding an image is a light emitting image or a no-light image. And, it is able to determine a presence or non-presence of a no-light image based on whether pixels over a prescribed value among numerous pixels amount to a value below a prescribed percentage. For instance, if pixels having a value over 30 amount to a value below 20%, it is an image closer to black since there are few pixels having bright color. So, it is decided as a no-light image. Otherwise, it can be determined as a light emitting image.

As a result of the decision in the step S220, if the image is the no-light image (‘Yes’ in the step S220), a valid part is extracted from the no-light image only via a validity check (S230). In this case, the validity check is to decide a presence or non-presence of validity as a no-light image. If there is an invalid part in the no-light image, a valid part of the no-light image is extracted only. In this case, the valid part means that pixels below a prescribed value among numerous pixels constructing the valid part amount to a value below a prescribed percentage. For instance, if pixels below 10 amount to 95%, the corresponding part can be called a valid part.

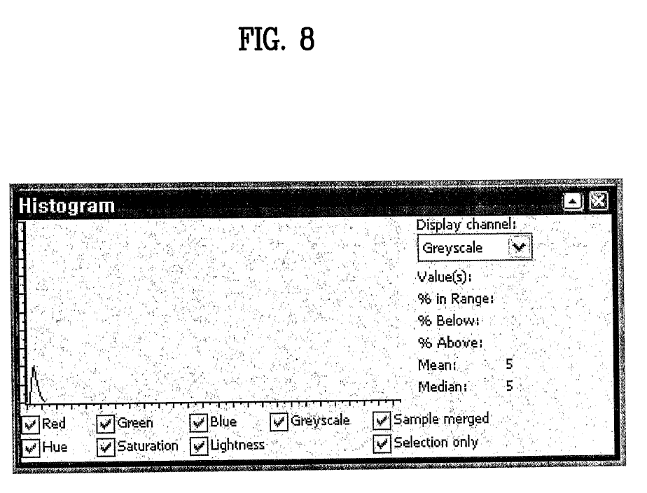

FIG. 8 is a diagram of an example of a histogram for validity check according to the present invention. A horizontal axis of a graph shown in FIG. 8 indicates a pixel value and a vertical axis indicates a number of pixels. It can be observed that most of pixels lean upon the values between 0˜10. In the step S230, the no-light image, on which validity check or valid part extraction is performed, is stored in a buffer (S240).

Subsequently, the routine goes back to the step S210 to repeat the steps S210 to S280 until an image reception is stopped (‘Yes’ in the step S280).

Meanwhile, in the step S220, if the received image is determined as the light emitting image instead of the no-light image (‘N’ in the step S220), a no-light image proper for correction of the light emitting image is selected from the no-light images stored in the buffer (S250). In this case, the proper no-light image means that a difference between a timing point of taking a light emitting image and a timing point of taking a no-light image lies within a range of a prescribed time. If a prescribed time in the step S240, i.e., a time interval of taking a no-light image is 1 minute, the prescribed time is preferably set to about 30 seconds. If the time interval is 5 minutes, the prescribed time is preferably set to about 2 minutes and 30 seconds.

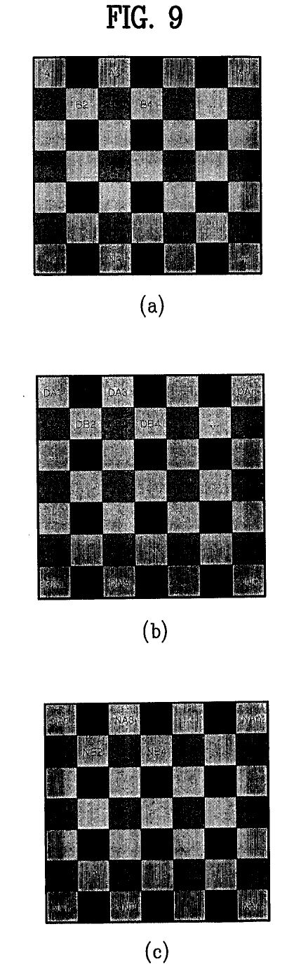

Thus, after the no-light image to be used for correction has been selected in the step S250, a corrected image is generated from subtracting a no-light image value from a light emitting image value (S260). FIG. 9 Shows bayer patterns of a light-emitting image, a no-light image, and a corrected image according to the present invention. As shown in the drawing, if a value of a random pixel of a light emitting image is Amn and if a random pixel of a no-light image is Dmn, a corrected image (Nmn) is generated from subtracting a no-light image value from a light emitting image value by the following Formula.

Nmn=Amn−Dmn (where ‘Nmn’, ‘Amn’, and ‘Dmn’ are a random pixel of a corrected image, a random pixel of a light emitting image, and a random pixel of a no-light image, respectively.)

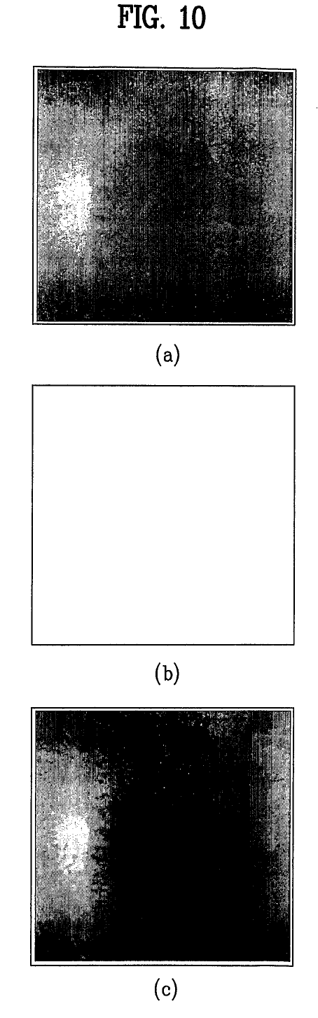

Since the no-light image value is subtracted from the light emitting image value, the noise by the dark current and the thermal noise can be eliminated. Through this process, FIG. 10 shows examples of a light-emitting image, a no-light image, and a corrected image according to the present invention. Referring to FIG. 10, it can be observed that an image quality of a corrected image (c) resulting from subtracting a no-light image (b) from a light emitting image (a) is enhanced considerably better than that of the light emitting image (a). Thus, it is able to obtain an image having a high image quality by eliminating the noises attributed to dark current and heat using a no-light image.

Subsequently, the image corrected in the step S280 is displayed on a screen (S270).

The routine then goes back to the step S210 to repeat the steps S210 to S280 until an image reception is stopped (‘Yes’ in the step S280).

While the present invention has been described and illustrated herein with reference to the preferred embodiments thereof, it will be apparent to those skilled in the art that various modifications and variations can be made therein without departing from the spirit and scope of the invention. Thus, it is intended that the present invention covers the modifications and variations of this invention that come within the scope of the appended claims and their equivalents.

### INDUSTRIAL APPLICABILITY

Accordingly, the present invention is applicable to processing of an image of an internal body acquired using a capsule type endoscope swallowable into a human body.

1. A method for processing an image acquired within a body by a capsule endoscope, comprising the step of:
(a) acquiring an image in a light emitting mode;
(b) acquiring an image in a no-light mode; and
(c) correcting the image acquired in the light emitting mode by the image acquired in the no-light mode.

2. The method according to claim 1, wherein the step (c) includes:
determining whether an image acquired in the step (a) and the step (b) is a light emitting image acquired in the light emitting mode or a no-light image acquired in the no-light mode;
extracting a correcting no-light image if the image is determined to be a no-light image;
correcting the light emitting image by the correcting no-light image; and
displaying the corrected light emitting image.

3. The method according to claim 2, wherein the light emitting image and a no-light image determine pixels having a value over 30 amount to a value below 20%, it is determined as a no-light image.

4. The method according to claim 2, wherein the correcting no-light image pixels having a value below 10 amount to a value over 95%, it is determined as a correcting no-light image.

5. The method according to claim 2, wherein correcting of the light emitting image subtract the extracted correcting no-light image value from the light emitting image value.

6. A capsule endoscope for processing an image acquired within a body, comprising:
a light source flickering in correspondence to a control signal;
an image sensor acquiring a light emitting image or a no-light image in correspondence to flickering of the light source;
an image processing unit correcting by subtract the acquired no-light image from the acquired light emitting image; and
a control unit controlling the flickering of the light source and the image processing.

7. The capsule endoscope according to claim 6, wherein the image processing unit determine whether the acquired image is a light emitting image or a no-light image, extract a correcting no-light image if the acquired image is determined to be a no-light image, correct by subtract the extracted correcting no-light image value from the light emitting image value.

8. The capsule endoscope according to claim 7, wherein the light emitting image and a no-light image determine pixels having a value over 30 amount to a value below 20%, it is determined as a no-light image.

9. The capsule endoscope according to claim 7, wherein the correcting no-light image pixels having a value below 10 amount to a value over 95%, it is determined as a correcting no-light image.

10. A capsule endoscope system for processing an image acquired within a body, comprising:
a capsule endoscope transmitting a light emitting image acquired in the light emitting mode and a no-light image acquired in the no-light mode; and,
an external processor receive the light emitting image and the no-light image from the capsule endoscope, wherein the external processor correcting the received light emitting image by the received no-light image.

11. The capsule endoscope system according to claim 10, wherein the external processor includes:
a receiving unit receiving a light emitting image and a no-light image from a capsule endoscope,
an image processing unit correcting the light emitting image by the no-light image, and
a display displaying the corrected image.

12. The capsule endoscope system according to claim 11, wherein the image processing unit determine whether the received image is a light emitting image or a no-light image, extract a correcting no-light image if the received image is determined to be a no-light image, correct by subtract the extracted correcting no-light image value from the light emitting image value.

13. The capsule endoscope system according to claim 12, wherein the light emitting image and a no-light image determine, pixels having a value over 30 amount to a value below 20%, it is determined as a no-light image.

14. The capsule endoscope system according to claim 12, wherein the correcting no-light image pixels having a value below 10 amount to a value over 95%, it is determined as a correcting no-light image.
